(19) United States
(12) Patent Application Publication
(10) Pub. No.: US 2012/0080063 A1
(43) Pub. Date: Apr. 5, 2012

(54) WASHING APPARATUS COMPRISING A CAPSULE-SHAPED WASHING CHAMBER

(75) Inventor: Keiji Kataoka, Okazaki-shi (JP)

(73) Assignee: FINE MACHINE KATAOKA CO., LTD., Anjo-shi (JP)

(21) Appl. No.: 13/019,588

(22) Filed: Feb. 2, 2011

(30) Foreign Application Priority Data
Oct. 1, 2010 (JP) 2010-224111

(51) Int. Cl. B08B 3/00

(52) U.S. Cl. 134/198

(57) ABSTRACT

The conventional washing apparatus has a double-cup washing tank that joins and separates to let work be placed therein, with nozzles set on the inner cup to allow a passage between it and the outer cup for spent liquid and/or air. The work is cleaned by washing detergent spirally flowing along the periphery of the inner cup by suction power within the passage, and then dried. Suction is not generated within the inner cup, so the spiral flow is too weak to make the tornado effect. This invention though resolves the above issues by an encased washing apparatus having a capsule-shaped washing chamber that joins and separates, has nozzles thereon, has a work table within that rotates by a drive device, has a drain at the bottom, and is characterized by washing detergent, cleaning water and/or air swirling by negative pressure within the washing chamber and then discharging into a drain.

### FIELD OF THE INVENTION

This invention relates to a capsule-shaped work washing apparatus (a work washing apparatus comprising a capsule-shaped washing chamber).

### BACKGROUND OF THE INVENTION

A conventional work washing apparatus has a casing (i.e. a case/box) structure in which a rotary work platform is provided with many nozzles that spray washing detergent, cleaning water and/or inject air toward the work. Thus, there are some negative effects such as the dispersion, adhesion and accumulation or the like of detergent and cleaning water within the casing. Another problem is that dirt or the like from the work attaches and accumulates within the casing. As such, additional work is required to remove the dirt from within the casing or the like, thus decreasing efficiency.

Here are two prior arts of a washing apparatus and equipment that may show how to solve the aforementioned problems.

Prior art Document One is “Japanese Published Unexamined Application No. 2004-89946” entitled, “Washing Apparatus” that refers to an inventive washing apparatus having a double-cup washing tank that joins and separates to let work be placed in it, with washing nozzles being provided on the inner cup of the double-cup structure to allow a flow passage between the inner and outer cups for discharging liquid and/or expelling air. Thus, the work is cleaned and dried in a hermetically enclosed washing tank. The invention is characterized by washing detergent being sprayed equally toward the work in a spiral flow to clean the work evenly and is characterized by the spiral flow being induced by suction power within the flow passage, with the spiral flow actually occurring along the periphery of the inner cup. Yet, since suction power is not generated within the inner cup (but along its periphery), such a spiral flow is too weak to induce the tornado effect, and since the double-cup washing tank is of semicircular shape, the spiral flow made within such a small area is limited. Also, of this structure, the work platform does not rotate, so much time is needed to clean the work. The invention is also characterized by the washing nozzles being integrated with the flow passage between the inner and outer cups to simplify the motion of the double-cup structure. Yet, this design makes the structure complicated and heavy. Thus, improvement is needed. Of this structure, the washing detergent, cleaning water and dirt or the like remaining on the work platform may spill out. Thus, handling and cleaning the apparatus is an issue.

Prior art Document Two is “Japanese Published Unexamined Application No. S58-210888” entitled, “Method for Washing and Drying Electrical Appliances.” This invention refers to a structure by which the work having been placed on a table is transferred to a hermetically sealed process chamber to be cleaned by water being sprayed by upper and lower nozzles, with the wastewater and dirt being expelled through a discharge pipe provided at the bottom of the process chamber. In this invention, no tornado effect is likely to happen and is not expected. Also, the work platform does not rotate, so it may take long to clean the work.

Patent Document One is “Japanese Published Unexamined Application No. 2004-89946.” Patent Document Two is “Japanese Published Unexamined Application No. S58-210888.”

### SUMMARY OF THE INVENTION

As described above, the prior inventions of Documents One and Two respectively have problems. They do not have the features of the present invention, as described below.

(a) A tornado effect is produced within an entirely hermetically sealed space, so that washing and drying are done efficiently with no dirt remaining inside the washing chamber, thus shortening the drying time.

(b) A tornado effect is produced within an entirely hermetically sealed space, so that within the washing chamber the dirt hurls downward with the washing detergent, cleaning water and/or air and does not remain inside, thus shortening the washing time and reducing the number of cleanings by the washing chamber, thus simplifying maintenance or the like.

(c) Nozzles for spraying washing detergent and cleaning water are provided on the upper movable half of the washing chamber that easily and smoothly raises and lowers, whilst a drain is provided at the bottom of the lower fixed half of the washing chamber.

(d) Nozzles for spraying washing detergent and cleaning water are set crosswise on the upper movable half of the washing chamber to produce a tornado effect to wash the work efficiently with no dirt remaining inside, thus shortening the washing time.

(e) A portal-shaped bracket with attached pipes, through which washing detergent, cleaning water and air flow respectively to the nozzles to be sprayed and injected onto the work expediently, is provided on the upper movable half of the washing chamber.

(f) A work platform is attached to a work table within the lower fixed half of the washing chamber to bring the work closer to the nozzles spraying the washing detergent, cleaning water and injecting air onto the work, thus producing a greater tornado effect to wash the work efficiently and to expel the dirt entirely from within the washing chamber, thus shortening the drying time or the like.

(g) A drain is provided at the bottom of the lower fixed half of the washing chamber to draw the now vaporized washing detergent and cleaning water and dirt or the like into a duct to be finally processed by a mist collector, so as to expel only purified air and not foul air into the factory.

### Means to Solving the Problems

The first aspect of this invention achieves the aforementioned features (a), (b) and (f).

The first aspect of this invention is aimed at achieving within a casing a washing apparatus comprising a capsule-shaped washing chamber that opens and closes, with nozzles being provided thereon, with a drain being provided at the bottom, with a work table rotated by a drive device being provided within, characterized in that washing detergent, cleaning water and/or air swirl within the washing chamber and then discharges into the drain.

The second aspect of this invention achieves the aforementioned feature (c).

The second aspect of this invention is aimed at achieving a washing apparatus as described in the first aspect of this invention, characterized in that the washing chamber comprises a lower fixed half and an upper movable half, with the upper movable half being raised and lowered by a piston rod.

The third aspect of this invention achieves the aforementioned features (a), (c) and (d).

The third aspect of this invention is aimed at achieving a washing apparatus as described in the first aspect of this invention, characterized in that nozzles are set crosswise on the upper movable half of the washing chamber, with the vertically aligned nozzles being used for spraying washing detergent and cleaning water, with the horizontally aligned nozzles being used for injecting air, and with a drain joined to a duct being provided at the bottom of the lower fixed half of the washing chamber.

The fourth aspect of this invention achieves the aforementioned feature (e).

The fourth aspect of this invention is aimed at achieving a washing apparatus as described in the first aspect of this invention, characterized in that atop the upper movable half of the washing chamber is attached a portal-shaped bracket to which are joined two guide bars that protrude through the top panel of the casing and are joined to a support plate above the casing, with a cylinder set vertically between the two guide bars above the casing being joined to the casing and to the support plate.

The fifth aspect of this invention achieves the aforementioned feature (g).

The fifth aspect of this invention is aimed at achieving a washing apparatus as described in the fourth aspect of this invention, characterized in that joined to the portal-shaped bracket of the upper movable half of the washing chamber are two pipes through which washing detergent, cleaning water and air flow respectively to the washing chamber by tubes being joined to the two pipes and to the nozzles set on the upper half of the washing chamber.

### Effect of the Invention

The first aspect of this invention refers to a washing apparatus within a casing, comprising a capsule-shaped washing chamber that opens and closes, with nozzles being provided thereon, with a drain being provided at the bottom, with a work table rotated by a drive device being provided within, characterized in that washing detergent, cleaning water and/or air swirl within the washing chamber and then discharges into the drain.

(a) A tornado effect is produced within an entirely hermetically sealed space, so that washing and drying are done efficiently with no dirt remaining inside the washing chamber, thus shortening the drying time.

(b) A tornado effect is produced within an entirely hermetically sealed space, so that within the washing chamber the dirt hurls downward with the washing detergent, cleaning water and/or air and does not remain inside, thus shortening the washing time and reducing the number of cleanings by the washing chamber, thus simplifying maintenance or the like.

(f) A work platform is attached to a work table within the lower fixed half of the washing chamber to bring the work closer to the nozzles spraying the washing detergent, cleaning water and injecting air onto the work, thus producing a greater tornado effect to wash the work efficiently and to expel the dirt entirely from within the washing chamber, thus shortening the drying time or the like.

The second aspect of this invention refers to a washing apparatus as described in the first aspect of this invention, characterized in that the washing chamber comprises a lower fixed half and an upper movable half, with the upper movable half being raised and lowered by a piston rod.

Therefore, the second aspect of this invention has the following feature.

(c) Nozzles for spraying washing detergent and cleaning water are provided on the upper movable half of the washing chamber that easily and smoothly raises and lowers, whilst a drain is provided at the bottom of the lower fixed half of the washing chamber.

The third aspect of this invention refers to a washing apparatus as described in the first aspect of this invention, characterized in that nozzles are set crosswise on the upper movable half of the washing chamber, with the vertically aligned nozzles being used for spraying washing detergent and cleaning water, with the horizontally aligned nozzles being used for injecting air, and with a drain joined to a duct being provided at the bottom of the lower fixed half of the washing chamber.

Therefore, the third aspect of this invention has the following features.

(a) A tornado effect is produced within an entirely hermetically sealed space, so that washing and drying are done efficiently with no dirt remaining inside the washing chamber, thus shortening the drying time.

(c) Nozzles for spraying washing detergent and cleaning water are provided on the upper movable half of the washing chamber that easily and smoothly raises and lowers, whilst a drain is provided at the bottom of the lower fixed half of the washing chamber.

(d) Nozzles for spraying washing detergent and cleaning water are set crosswise on the upper movable half of the washing chamber to produce a tornado effect to wash the work efficiently with no dirt remaining inside, thus shortening the washing time.

The fourth aspect of this invention refers to a washing apparatus as described in the first aspect of this invention, characterized in that atop the upper movable half of the washing chamber is attached a portal-shaped bracket to which are joined two guide bars that protrude through the top panel of the casing and are joined to a support plate above the casing, with a cylinder set vertically between the two guide bars above the casing being joined to the casing and to the support plate.

Therefore, the fourth aspect of this invention has the following feature.

(e) A portal-shaped bracket with attached pipes, through which washing detergent, cleaning water and air flow respectively to the nozzles to be sprayed and injected onto the work expediently, is provided on the upper movable half of the washing chamber.

The fifth aspect of this invention refers to a washing apparatus as described in the fourth aspect of this invention, characterized in that joined to the portal-shaped bracket of the upper movable half of the washing chamber are two pipes through which washing detergent, cleaning water and air flow respectively to the washing chamber by tubes being joined to the two pipes and to the nozzles set on the upper half of the washing chamber.

Therefore, the fifth aspect of this invention has the following feature.

(g) A drain is provided at the bottom of the lower fixed half of the washing chamber to draw the now vaporized washing detergent and cleaning water and dirt or the like into a duct to be finally processed by a mist collector, so as to expel only purified air and not foul air into the factory.

### BRIEF DESCRIPTIONS OF THE FIGURES

FIG. 1 is a perspective view of the washing apparatus comprising the enclosed capsule-shaped washing chamber of this invention.

FIG. 2 is a conceptual side view of the washing apparatus without hoses.

FIG. 3 is the conceptual top view of the washing apparatus.

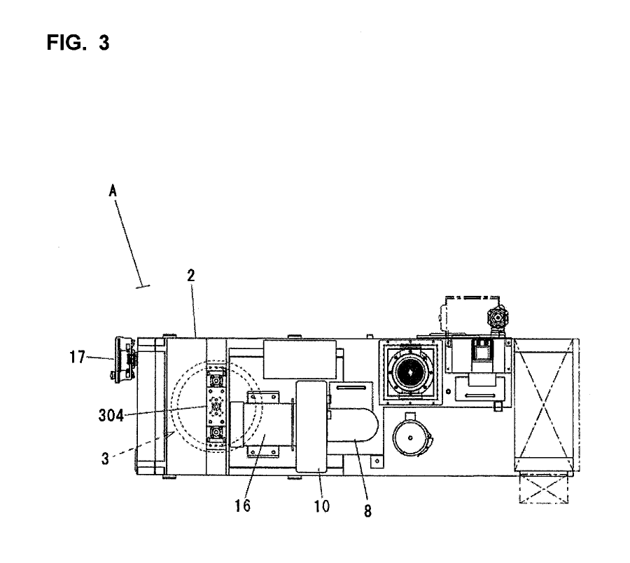

FIG. 4 is the conceptual frontal view of the washing apparatus without hoses.

FIG. 5 is an enlarged schematic view of the branch hoses and pipes through which the washing detergent, cleaning water and air flow respectively to the washing chamber by tubes running from the pipes to the nozzles on the washing chamber.

FIG. 6 is a simplified schematic view of both the tornado effect within the washing chamber and of the suction pump drawing the now vaporized washing detergent and cleaning water and the air into the drain and through the duct.

FIG. 7 shows the flow circuit of the washing detergent, cleaning water and the air.

### PREFERRED EMBODIMENTS

The base 1 is the bottom unit of the washing apparatus A. The casing 2 is fixed upon the base 1. The casing 2 has a window 300 on both sides and a work entrance 201 in front. A washing chamber 3 provided within the casing 2 comprises a lower fixed half 300 with a support structure (not shown) built within the casing 2 and an upper movable half 301 (that can be separated from the lower fixed half 300) to form a hermetically enclosed space.

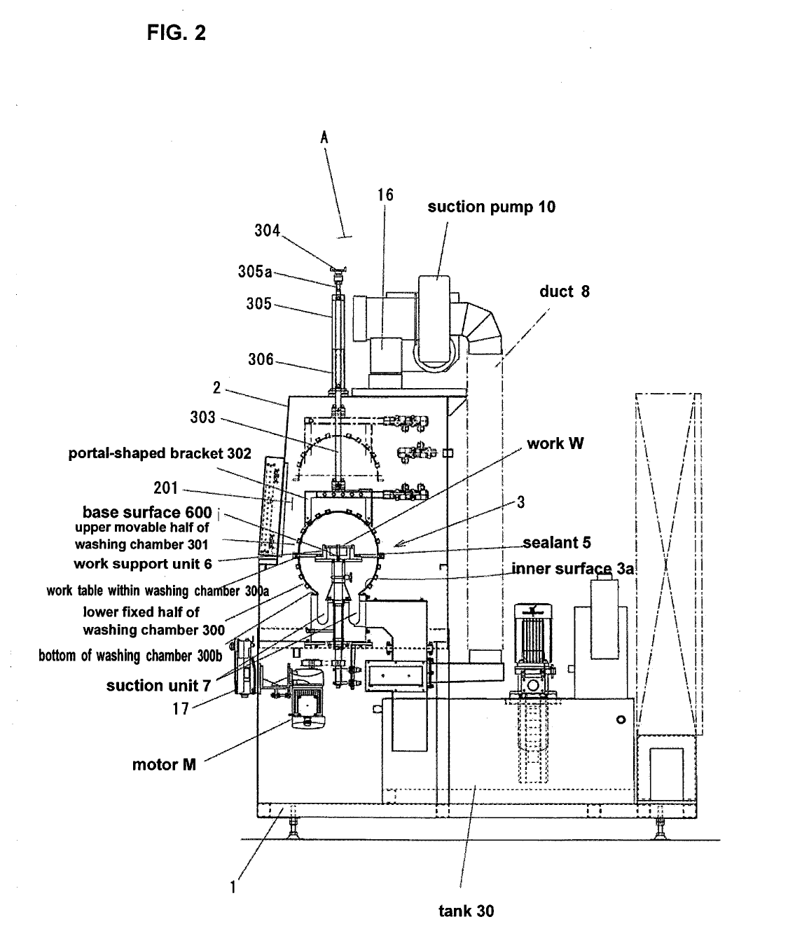

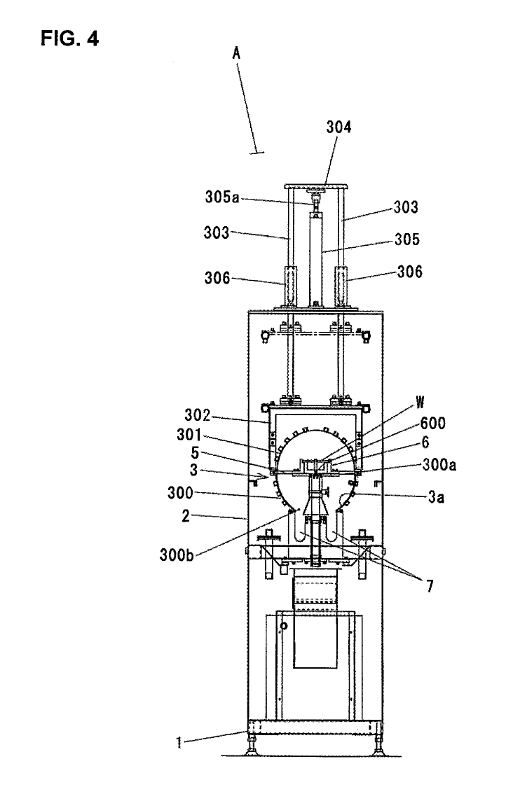

The upper movable half 301 of the washing chamber 3 is provided within the casing 2. The embodiment shows the upper movable half 301 being a structure of which to a portal-shaped bracket 302 are joined two guide bars 303 that protrude through the top panel of the casing 2 and are attached to the support plate 304. A cylinder 305 is set vertically between the two guide bars 303 and is attached to the top panel of the casing 2 and to the support plate 304. When the piston rod 305a within the cylinder 305 rises, the two guide bars 303 (by being attached to the support plate 304) also rise. Simultaneously the portal-shaped bracket 302 (by being joined to the two guide bars 303) rises to lift the upper movable half 301 of the washing chamber 3 off of the lower fixed half 300 of the washing chamber 3. When the piston rod 305a within the cylinder 305 falls, the two guide bars 303 (by being attached to the support plate 304) also fall. Simultaneously the portal-shaped bracket 302 (by being joined to the two guide bars 303) falls to lower the upper movable half 301 of the washing chamber 3 onto the lower fixed half 300 of the washing chamber 3 to form a hermetically enclosed space. The sealant 5 is shown in FIG. 2 and FIG. 4. The two sleeves 306 partly cover the two guide bars 303 that protrude through the top panel of the casing 2.

A work support unit 6 with a work platform 600 is provided on a work table 300a within the lower fixed half 300 of the washing chamber 3 to shorten the distance B between the work W and the nozzles spraying washing detergent and cleaning water and injecting air onto the work, as described below, so as to produce a greater tornado effect C to efficiently wash the work without leaving dirt on the inner surface 3a of the washing chamber 3 and to shorten the drying time of the work W. The work table 300a is rotated by a motor reducer and/or transmission mechanism or the like linked to a motor M.

A drain 7 is provided at the bottom 300b of the lower fixed half 300 of the washing chamber 3 and is joined to a duct 8 that is joined to a suction pump 10. Whilst the washing chamber 3 is in use, the suction pump 10 with the duct 8 and the drain 7 keep negative pressure within the hermetically sealed washing chamber 3 to produce the tornado effect C which instantly draws the washing detergent, cleaning water, air and the dirt from the washing chamber 3.

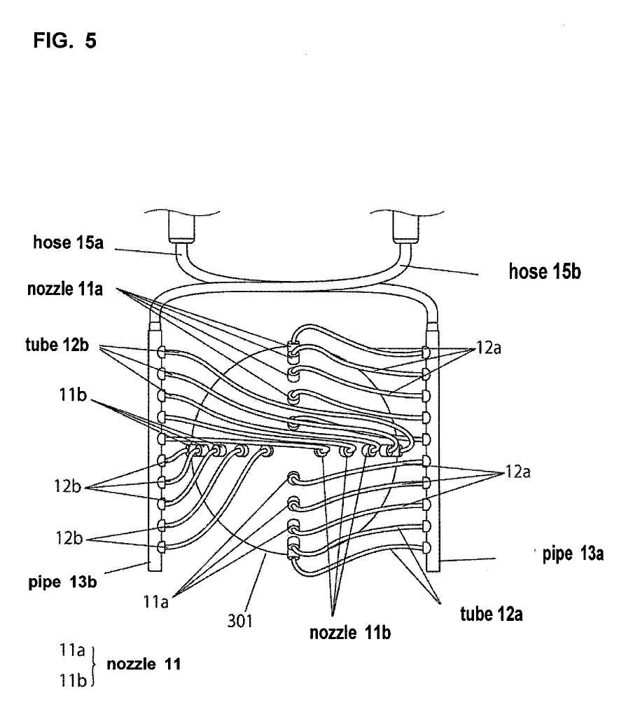

FIG. 5 shows many nozzles 11 set crosswise on the upper movable half 301 of the washing chamber 3. The vertically aligned nozzles 11a spray washing detergent and cleaning water. The horizontally aligned nozzles 11b inject air. Nozzles 11a, 11b are joined to a supply source by the tubes 12a, 12b being joined to the pipes 13a, 13b and they in turn joined to the hoses 15a, 15b. Thus, from a supply source the washing detergent and cleaning water flow through the hose 15a, the pipe 13a and the tube 12a to be sprayed by the nozzle 11a into the hermetically sealed washing chamber 3, whilst from a supply source the air flows through the hose 15b, the pipe 13b and the tube 12b to be injected by the nozzle 11b into the hermetically sealed washing chamber 3. This embodiment is improved practically by having the portal-shaped bracket 302 bear the pipes 13a, 13b as well as the upper movable half 301 of the washing chamber 3 to make the portal-shaped bracket 302 more useful, so as not need to have to add another device to bear the pipes 13a, 13b, thus reducing cost and letting the washing apparatus A be made smaller to economize factory space.

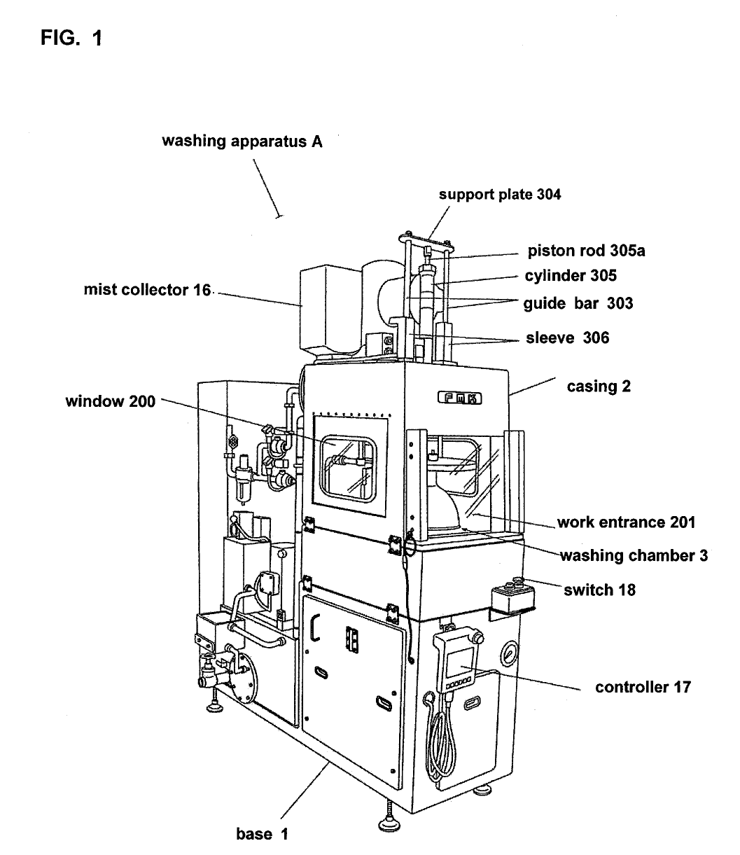

FIG. 1 shows respectively the mist collector 16, the controller 17 and the switch 18.

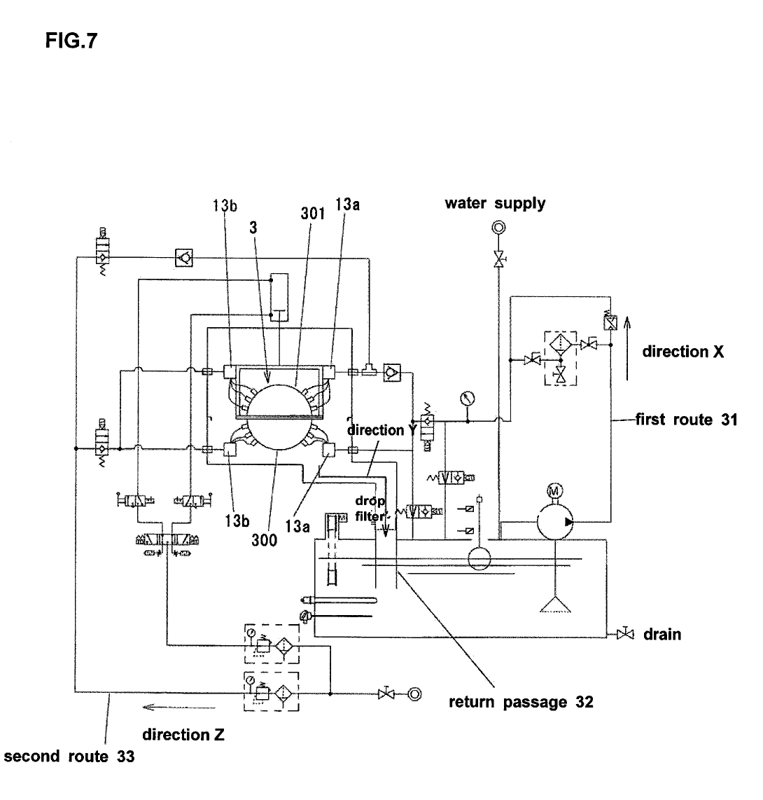

FIG. 7 shows the direction of flow of the washing detergent, cleaning water (herein referred to as the water) and of the air. The water flows along the first route 31 that is joined to various devices including the tank 30 (not shown) and then is supplied in direction X to the water pipe 13a. The wastewater flows through the return passage 32 that has a filter branching from the drain 7 and then flows in the direction Y to the tank 30 to be reused. The air flows along the second route 33 that is joined to various devices including the blower (not shown) and then is supplied in the direction Z to the air pipe 13b. The dirty air is drawn by the suction pump 10 into the drain 7 and through the duct 8 to be processed by the mist collector 16 and then is emitted into the factory as purified air.

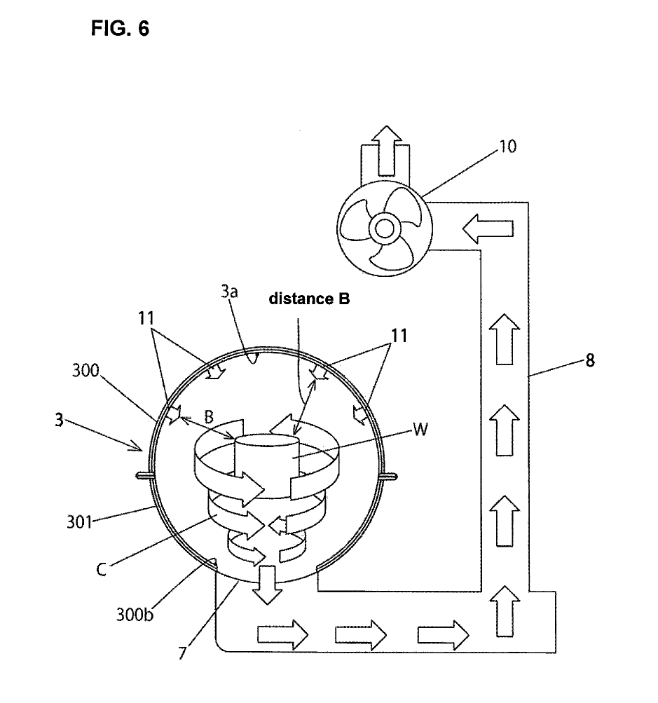

To use this invention, open the work entrance 201 and set the work W on the work platform 600. Close the work entrance 201. The work W therefore sits on the work platform 600 of the work support unit 6 which is attached to the rotary work table 300a within the lower fixed half 300 of the washing chamber 3. Engage the switch 18 to start the motor M to rotate the work table 300a amidst the spraying water and injecting air by the aligned nozzles 11a, 11b respectively. FIG. 6 shows the swirling water of the tornado effect C by the negative pressure within the washing chamber 3 cleaning the work W wholly in a short time. The wastewater by specific gravity then discharges into the drain 7 to return to the tank 30. The exhaust vapor flows through the duct 8 to be processed by the mist collector 16.

Air is then injected by the nozzles 11b to dry the work W. FIG. 6 shows the whirling air of the tornado effect C by the negative pressure within the washing chamber 3 drying the work W wholly in a short time. The moist dirty air by specific gravity then discharges into the drain 7 to flow through the duct 8 to be processed by the mist collector 16.

After the work W has dried, disengage the switch 18. Open the work entrance 201. Remove the processed work W from the work platform 600. The operation is done.

Although it is not shown in the figures, the work W can be placed and removed automatically.

### EXPLANATION OF THE ALPHA NUMERALS

1 base
2 casing
200 window
201 work entrance
3 washing chamber
3a inner surface of washing chamber
300 lower fixed half of washing chamber
300a work table within washing chamber
300b bottom of washing chamber
301 upper movable half of washing chamber
302 portal-shaped bracket
303 guide bar
304 support plate
305 cylinder
305a piston rod
306 sleeve
5 sealant
6 work support unit
600 work platform
7 drain
8 duct
10 suction pump
11 nozzle
11a nozzle
11b nozzle
12a tube
12b tube
13a pipe
13b pipe
15a hose
15b hose
16 mist collector
17 controller
18 switch
30 tank
31 first route
32 return passage
33 second route
A washing apparatus
B distance
C tornado effect
M motor
W work

We claim:

1. A washing apparatus within a casing, comprising a capsule-shaped washing chamber that opens and closes, with nozzles being provided thereon, with a drain being provided at the bottom, with a work table rotated by a drive device being provided within, characterized in that washing detergent, cleaning water and/or air swirl within the washing chamber and then discharges into the drain.

2. A washing apparatus as described in claim 1, characterized in that the washing chamber comprises a lower fixed half and an upper movable half, with the upper movable half being raised and lowered by a piston rod.

3. A washing apparatus as described in claim 1, characterized in that nozzles are set crosswise on the upper movable half of the washing chamber, with the vertically aligned nozzles being used for spraying washing detergent and cleaning water, with the horizontally aligned nozzles being used for injecting air, and with a drain joined to a duct being provided at the bottom of the lower fixed half of the washing chamber.

4. A washing apparatus as described in claim 1, characterized in that atop the upper movable half of the washing chamber is attached a portal-shaped bracket to which are joined two guide bars that protrude through the top panel of the casing and are joined to a support plate above the casing, with a cylinder set vertically between the two guide bars above the casing being joined to the casing and to the support plate.

5. A washing apparatus as described in claim 4, characterized in that joined to the portal-shaped bracket of the upper movable half of the washing chamber are two pipes through which washing detergent, cleaning water and air flow respectively to the washing chamber by tubes being joined to the two pipes and to the nozzles set on the upper half of the washing chamber.
